(19) United States
(12) Patent Application Publication
(10) Pub. No.: US 2017/0298214 A1
(43) Pub. Date: Oct. 19, 2017

(54) THINWALL MOLDABLE CODUCTIVE COMPOSITIONS WITH IMPROVED PHYSICAL PROPERTIES AND USES THEREOF

(71) Applicant: SABIC Global Technologies B.V., Bergen op Zoom (NL)

(72) Inventor: Mohammad MONIRUZZAMAN, Exton, PA (US)

(21) Appl. No.: 15/517,414

(22) PCT Filed: Oct. 14, 2015
(86) PCT No.: PCT/US15/55464

§ 371 Date: Apr. 6, 2017

Related U.S. Application Data
(60) Provisional application No. 62/067,248, filed on Oct. 22, 2014.

(51) Int. Cl. C08L 23/12; C08K 3/04; C08K 5/103; C08K 5/14

(52) U.S. Cl. CPC C08L 23/12; C08K 5/14; C08K 3/04; C08K 5/103

(57) ABSTRACT

The disclosure concerns thermoplastic compositions exhibiting electrically conductive properties as well as improved mechanical and physical properties. Disclosed herein are also methods for the manufacture of the disclosed composition as well as articles of manufacture comprising the same.

### RELATED APPLICATIONS

This application claims benefit to U.S. Patent Application No. 62/067,248, filed on Oct. 22, 2014, the disclosure of which is incorporated herein in its entirety for any and all purposes.

### TECHNICAL FIELD

The disclosure concerns polypropylene compositions exhibiting electrical conductivity and static dissipative properties, while maintaining improved physical properties such as flow, ductility, and impact strength.

### BACKGROUND

Typically, electrical conductivity of a thermoplastic polymer composition can be achieved via the introduction of electrically conductive fillers into the polymer matrix. These conductive materials can also serve as electrostatic dissipative materials and prevent the accumulation of potentially dangerous charges.

### SUMMARY

When introducing fillers into a resin composition, the electrical conductivity or static dissipative capability gained can be accompanied by unfavorable effects on other physical properties of the composition. High filler loading causes poor flow properties, which in turn can reduce the processability of the composition. The low flow specifically reduces the thin wall molding ability. There is a need in the art for electrically conductive polymer composites that provide thin wall moldability and have good flow, mold release performance, ductility, and Izod impact strength properties. Disclosed in various aspects herein are thin walled moldable, electrically conductive thermoplastic compositions having improved flow, ductility, and impact strength.

The above-described and other deficiencies are met by a composition comprising: (a) from about 75 wt. % to about 84 wt. % of a polypropylene polymer component, wherein the polypropylene polymer component comprises a polypropylene copolymer and a polypropylene homopolymer; (b) from about 15 wt. % to about 25 wt. % of an electrically conductive filler component; (c) from about 0.01 wt. % to about 0.05 wt. % of a polymer chain modifier component; and from about 0.5 wt. % to about 1 wt. % of a mold release additive, wherein the combined weight percent value of all components does not exceed about 100 wt. %, and wherein all weight percent values are based on the total weight of the composition, and wherein the composition has (i) a surface resistivity of less than about 200 ohm/sq.; (ii) a notched Izod impact strength of greater than about 300 J/m measured at 23° C.; (iii) a 100% ductility in notched and unnotched Izod impact tests; (iv) a melt volume rate of greater than about 15 cm³/10 min at 190° C. and 2.16 kg load; and (v) a good mold release performance exhibited by an ejection pressure of less than 500 psi.

In various aspects, the disclosure relates to articles comprising compositions disclosed herein. For example, the disclosed composition relates to thin walled articles comprising the disclosed composition. In this regard, a thin wall is a section of a product that is more narrow when compared to its length and width. As disclosed herein, a thin wall can have a nominal thickness of less than about 3 mm. The thin walled article can be processed for use in an array of fields, for example, as a housing for a consumer electronic device.

In a further aspect, the present disclosure pertains to methods of preparing thin walled, moldable conductive thermoplastic compositions.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### DETAILED DESCRIPTION

The disclosed thermoplastic composition comprises: (a) from about 75 wt. % to about 84 wt. % of a polypropylene polymer component, wherein the polypropylene polymer component comprises a polypropylene copolymer and a polypropylene homopolymer; (b) from about 15 wt. % to about 25 wt. % of an electrically conductive filler component; (c) from about 0.01 wt. % to about 0.05 wt. % of a polymer chain modifier component; and from about 0.5 wt. % to about 1 wt. % of a mold release additive, wherein the combined weight percent value of all components does not exceed about 100 wt. %, and wherein all weight percent values are based on the total weight of the composition. The disclosed thermoplastic composition can have (i) a surface resistivity of less than about 200 ohm/sq.; (ii) a notched Izod impact strength of greater than about 300 J/m measured at 23° C.; (iii) a 100% ductility in notched and unnotched Izod impact tests; (iv) a melt volume rate of greater than about 15 cm³/10 min at 190° C. and 2.16 kg load; and (v) a good mold release performance exhibited by an ejection pressure of less than 500 psi.

Traditionally suitable insulators, polymeric resins can be made conductive or static-dissipative upon the addition of conductive fillers. The addition of such materials can create systems of particles within the polymer matrix that allows electric charges to conduct through the insulating polymer. However, high loading of conductive fillers often results in the composite polymer compositions having poor flow, ductility, and impact properties which ultimately negatively impact the processing of the polymer. The disclosed composition provides electrically conductive filled thermoplastic compositions while maintaining high flow, appropriate mold releasability, improved notched and unnotched Izod impact strength, and good ductility. The disclosed composition meets these and other needs where the composition comprises: (a) from about 75 wt. % to about 84 wt. % of a polypropylene polymer component wherein the polypropylene polymer component comprises a polypropylene copolymer and a polypropylene homopolymer; (b) from about 15 wt. % to about 25 wt. % of an electrically conductive filler component; and (c) from about 0.01 wt. % to about 0.05 wt. % of a polymer chain modifier component; and (d) from about 0.5 wt. % to about 1 wt. % of a mold release additive; wherein the combined weight percent value of all components does not exceed about 100 wt. %, wherein all weight percent values are based on the total weight of the composition, and wherein the disclosed composition can have (i) a surface resistivity of less than about 200 ohm/sq.; (ii) a notched Izod impact strength of at least about 300 J/m at 23° C.; (iii) 100% ductility in notched and unnotched Izod impact tests; a melt volume rate of greater than about 15 cm³/10 minutes at 190° C. and under 2.16 kg load; and a good mold release performance exhibited by an ejection pressure of less than 500 psi. In an aspect, the polypropylene homopolymer can have a melt flow index of greater than about 25 g/10 minutes as measured according to a temperature of about 230° C. and under 2.16 kg load. The polypropylene copolymer can have a melt flow index of more than about 10 g/10 min at a temperature of about 230° C. and under 2.16 kg load and a notched Izod impact strength of greater than about 180 J/m measured at room temperature. In further aspects, the conductive filler can be carbon black. The mold additive can be pentaerythritol stearate.

The disclosed composition of the invention exhibits electrically conductive properties while maintaining impact strength, flow, and ductility. In some aspects, the disclosed composition can exhibit improved mold release performance. The composition can comprise a mold release additive. For example, the composition can comprise a mold release additive in an amount from about 0.2 wt. % to about 2 wt. % of the total weight of the composition. As a further example, the compositions can comprise pentaerythritol stearate as a mold additive.

As used herein, the term “electrically conductive filler” or “electrically conductive additive” refers to any additive, or filler which is typically inorganic, and that has an electrical conductivity higher than the polymer matrix and can help to increase the electrical conductivity of polymer materials if introduced into the polymer formulation and enable the polymer for use in static dissipative applications. Common electrically conductive fillers include carbon nanotubes, carbon fibers, carbon black, metallic fillers, non-conductive fillers coated with metallic coatings, or non-metallic fillers.

### Polypropylene Polymer Component

As used herein, the term “polypropylene” refers to a polymer comprising at least 95 wt. %, based on the weight of the polypropylene, of repeating units derived from propylene (i.e., —CH₂—CH(CH₃)— units). In some embodiments, the polypropylene can comprise at least 98 wt. %, based on the weight of the polypropylene, of repeating units derived from propylene. When the polypropylene is a copolymer of propylene and another copolymerizable monomer, the other copolymerizable monomer can be, for example, ethylene, a C₄-C₁₂ alkene, a C₁-C₆-alkyl acrylate, a C₁-C₆-alkyl methacrylate, or a mixture of two or more of the foregoing monomers. In some aspects, the polypropylene can be a homopolymer of propylene. The polypropylene can be syndiotactic, isotactic, or atactic. For example, the polypropylene can be atactic.

In an aspect, the polypropylene component of the disclosed composition can comprise a polypropylene homopolymer and a polypropylene copolymer. In a further example, the composition can comprise a polypropylene homopolymer and a polypropylene copolymer wherein the propylene homopolymer is the minor component of the polypropylene polymer component. Minor component refers to the polypropylene homopolymer comprising less than half of the total weight of the polypropylene polymer component. In another example, the polypropylene polymer component can comprise from about 15 wt. % to about 35 wt. % of a polypropylene homopolymer and from about 65 wt. % to about 85 wt. % of a polypropylene copolymer. In a yet further example, the polypropylene polymer component can comprise from about 25 wt. % to about 35 wt. % of a polypropylene homopolymer and from about 65 wt. % to about 75 wt. % of a polypropylene copolymer

In some aspects, the polypropylene component comprises a polypropylene homopolymer and a polypropylene copolymer. In an example, the polypropylene homopolymer can have a melt flow index (MFI) of greater than about 25 g/10 minutes as measured at 230° C. and under 2.16 kg of load. In a further example, the polypropylene copolymer can have a notched Izod impact strength of greater than about 180 J/m as measured at 23° C. and a melt flow index of greater than about 10 g/10 minutes as measured at 230° C. and under a 2.16 kg load.

### Conductive Filler

Electrostatic discharges (ESD) can be detrimental to electronic components, resulting in failures, reduced reliability and increased costs, and latent component failures in deployed equipment. Polymeric materials are typically good insulators, but can become conductive or static-dissipative upon the addition of conductive fillers, such as, metallic fillers, non-conductive fillers coated with metallic coatings, or electrically conductive non-metallic fillers, as well as carbon based fillers such as carbon nanotubes, carbon fibers, and carbon black. The addition of such materials creates network of interconnecting particles within the polymer matrix, allowing electric charges to conduct through the insulating polymer. In some aspects, the disclosed composition can comprise an electrically conductive filler. As an example, the composition can comprise conductive fillers for the dissipation of static electrical charges.

Carbon based fillers can be used as electrically conductive fillers in thermoplastics. Carbon nanotubes are often single wall carbon nanotubes (SWNTs), multiwall carbon nanotubes (MWNTs), or vapor grown carbon fibers (VGCF). Single wall carbon nanotubes (SWNTs may be produced by laser-evaporation of graphite, carbon arc synthesis or a high-pressure carbon monoxide conversion process (HIPCO) process. These SWNTs generally have a single wall comprising a graphene sheet with outer diameters of about 0.7 to about 2.4 nanometers (nm). MWNTs are derived from processes such as laser ablation and carbon arc synthesis, and have at least two graphene layers bound around an inner hollow core. MWNTs generally have diameters of about 2 to about 50 nm. Vapor grown carbon fibers (VGCF) are generally manufactured in a chemical vapor deposition process. VGCF having “tree-ring” or “fishbone” structures may be grown from hydrocarbons in the vapor phase, in the presence of particulate metal catalysts at moderate temperatures, i.e., about 800° C. to about 1500° C. Carbon nanotubes are generally used in amounts of about 0.001 wt. % to about 80 wt. % of the total weight of an electrically conductive composition.

Various types of electrically conductive carbon fibers can also be used in the electrically conductive composition. Carbon fibers are generally classified according to their diameter, morphology, and degree of graphitization (morphology and degree of graphitization being interrelated). These characteristics are presently determined by the method used to synthesize the carbon fiber. For example, carbon fibers having diameters down to about 5 micrometers, and graphene ribbons parallel to the fiber axis (in radial, planar, or circumferential arrangements) are produced commercially by pyrolysis of organic precursors in fibrous form, including phenolics, polyacrylonitrile (PAN), or pitch. The carbon fibers generally have a diameter of greater than or equal to about 1,000 nanometers (1 micrometer) to about 30 micrometers. Carbon fibers are generally used in amounts of about 0.001 wt. % to about 50 wt. % of the total weight of the resin.

Carbon black can be used as a conductive filler in thermoplastic resins. Electrically conductive carbon black is a conductive powder commercially available and sold under an array of trade names including S. C. F. (Super Conductive Furnace), E. C. F. (Electric Conductive Furnace), Ketjen Black EC (available from Akzo Co., Ltd.) or acetylene black. The properties of carbon black influence the characteristics of the polymer matrix to which it is introduced. The particle size or surface area, the degree of structure and the corresponding amount of void space among the particles, and porosity influence the level of conductivity as well as flow. Carbon black particles can form porous aggregates (clusters of particles) which are strongly attached to one another by physical forces such as van der Waals forces. The aggregates in turn can cluster into agglomerates which are held together by weaker forces. Further, the aggregates can be compressed in size by forces such as shear present during thermoplastic formation and processing, such as during extrusion.

In an aspect, the conductive filler of the present disclosure can comprise carbon black. The conductive filler can comprise carbon black having a density of about 0.2 g/cc. The carbon black can have a surface area of at least about 50 m²/g, or more specifically, at least about 60 m²/g.

Carbon black can be used in amounts of about 0.01 wt. % to about 50 wt. % of the total weight of an electrically conductive composition. In one aspect, carbon black is used in an amount of from about 15 wt. % to about 25 wt. %, based on the weight of the disclosed thermoplastic composition. In another embodiment, carbon black is used in amounts of about 17 wt. % to about 23 wt. %, based on the total weight of the thermoplastic composition. For example, the thermoplastic composition can comprise about 19 wt. % of carbon black.

### Polymer Chain Modifier Additive

A polyolefin polymer can be degraded to lower molecular weights via chain scission. This chain scission, also known as visbreaking, gives the resin a lower average molecular weight, or a narrower molecular weight distribution (MWD). For these resins, the narrowed MWD can provide improved flowability and processability. Accordingly, directed chain scission in a polymer is commonly referred to as “controlled rheology.” Polypropylene polymers often feature higher MWD and are susceptible to molecular weight degradation. The process of visbreaking occurs naturally or via the introduction of a chemical additive into a polypropylene resin. At certain temperatures or as a result of UV exposure, the degradation occurs naturally as the unstabilized polypropylene oxidizes. In the alternative, an additive is introduced to induce chain scission. In an aspect, the disclosed composition comprises an additive configured to modify polymer chain length and the molecular weight distribution of a polymer. In a further example, the disclosed composition comprises a polymer chain modifier additive configured to modify the molecular weight distribution of a polypropylene polymer. In an even further example, the polymer chain modifier additive comprises a peroxide.

The degradation of polypropylene by peroxide is thought to proceed through a series of free radical reactions (I). Peroxide thermally decomposes by a homolytic scission to produce peroxy radicals which then react with the backbone of the polypropylene polymeric chains and ultimately degrade the polymer backbone through a beta scission reaction. The resulting polymeric radicals then terminate via disproportionation.

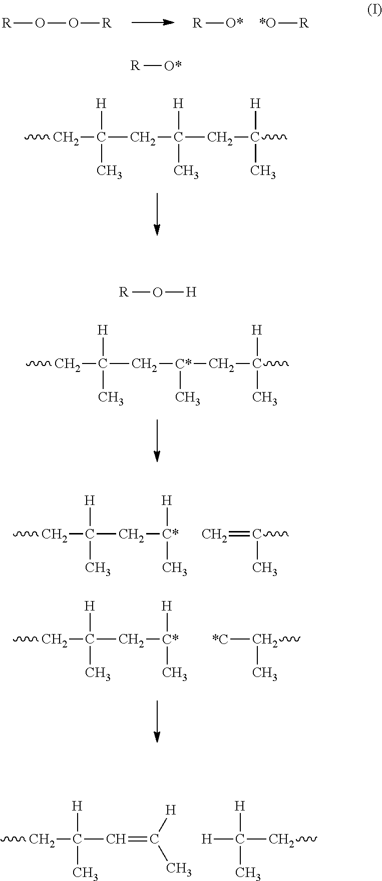

This peroxide induced chain scission thereby provides shorter polymer chain lengths which creates a narrower molecular weight distribution of the polypropylene polymer.

In various aspects, the polymer chain modifier additive of the disclosed composition comprises a peroxide. For example, the additive can be an organic peroxide such as tert-butyl hydroperoxide, tert-amyl hydroperoxide, pinnae hydroperoxide, cumene hydroperoxide, 2,5-dimethyl-2,5-di(hydroperoxy)hexane, diisopropylbenzene monohydroperoxide, dibenzoyl peroxide, p-chlorobenzoyl peroxide, lauroyl peroxide, 3,5,5-trimethylhexanoyl peroxide, acetyl peroxide, 2,5-dimethyl-2,5-di(benzoylperoxy)hexane, 2,5-dimethyl-2,5-di(2-ethylhexanoylperoxy)hexane, 2,2-di(tert-butylperoxy)butane, 2,2-di(tert-amyl)peroxypropane, 4-(tert-amylperoxy)-4-methyl-2-pentanol, 1,1-di(tert-butylperoxy)cyclohexane, 2,2-bis(4,4-di-tert-butylperoxycyclohexyl)propane, 2,5-dimethyl-2,5-di(tert-butylperoxy)-3-hexyne, di-tert-butyl peroxide, di-tert-amyl peroxide, 1,4-di(tert-butylperoxyisopropyl)benzene, 2,5-dimethyl-2,5-di(tert-butylperoxy)hexane, 1,1,4,4,7,7-hexamethylcyclo-4,7-diperoxynonane, 3,3,6,6,9,9-hexamethylcyclo-1,2,4,5-tetraoxanonane, 3,6,6,9,9-pentamethyl-3-n-propyl-1,2,4,5-tetraoxacyclononane, 3,6,6,9,9-pentamethyl-3-(ethyl acetate)-1,2,4,5-tetraoxacyclononane, or 3-phenyl-3-tert-butylperoxyphthalide. The polymer chain modifier additive can comprise a peroxide in a polypropylene carrier.

In an aspect, the thermoplastic composition can comprise a polymer chain modifier in an amount from about 0.01 wt. % to about 0.05 wt. % of the total weight of the thermoplastic composition. For example, the thermoplastic composition can comprise a peroxide in an amount from about 0.01 wt. % to about 0.05 wt. % of the total weight of the thermoplastic composition.

### Mold Release Agent

In one aspect, the thermoplastic composition further comprises a mold release additive. There is considerable overlap among additives such as plasticizers, lubricants, and/or mold release agents, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), bis(diphenyl)phosphate of hydroquinone and the bis(diphenyl)phosphate of BPA; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; block copolymers of polyethylene oxide and polypropylene oxide, such as the Pluronic™ family of copolymers; waxes such as beeswax, montan wax, paraffin wax and the like; and poly alpha olefins such as Ethylflo™ 164, 166, 168, and 170. In one aspect, exemplary mold releasing additives include for example, without limitation, metal stearate, stearyl stearate, pentaerythritol tetrastearate, beeswax, montan wax, paraffin wax, or the like, or combinations including at least one of the foregoing mold release additives. For example, the mold release additive comprises pentaerythritol stearate.

Mold releasing additives are generally used in amounts of from 0.1 to 1.0 parts by weight, based on 100 parts by weight of the total composition, excluding any filler. In an aspect, the disclosed composition can comprise a mold release additive in an amount from about 0.2 wt. % to about 2 wt. %. As an example, the thermoplastic composition can comprise pentaerythritol stearate in an amount from about 0.2 wt. % to about 2 wt. % of the total composition.

In one aspect, the thermoplastic composition comprising the mold release additive has better mold release performance compared to a substantially identical reference composition in the absence of the mold release composition, and wherein the presence of the mold release composition has substantially no negative impact on the mechanical and physical properties.

In an aspect, mold release performance can be assessed according to the ejection pressure required to discharge a molded sample from a mold. For example, the thermoplastic composition comprising the mold release composition has a lower ejection pressure compared to a substantially identical reference composition in the absence of the mold release composition, and wherein the presence of the mold release composition has substantially no negative impact on the mechanical and physical properties. For a given sample a mold release ejection pressure of greater than 750 psi, indicates a poor mold release performance and a mold release ejection pressure of less than 500 psi indicates a good mold release performance. As an example, molded samples of the thermoplastic composition can exhibit an ejection pressure of less than about 500 psi. In a further example, the ejection pressure of a molded sample of the thermoplastic composition can be about 500 psi.

### Other Additives

The thermoplastic compositions as described herein are suitable for use in a wide variety of compositions and applications as is known in the art. The thermoplastic composition can comprise one or more additives selected to achieve a desired property, with the proviso that the additive(s) are also selected so as to not significantly adversely affect a desired property of the thermoplastic composition. The additive composition or individual additives can be mixed at a suitable time during the mixing of the components for forming the composition. The additive can be soluble and/or non-soluble in polymer.

The additive composition can include an impact modifier, flow modifier, filler (e.g., a particulate polytetrafluoroethylene (PTFE), glass, carbon, mineral, or metal), reinforcing agent (e.g., glass fibers), impact modifier, antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g, a dye or pigment), surface effect additive, radiation stabilizer, flame retardant, anti-drip agent (e.g., a PTFE-encapsulated styrene-acrylonitrile copolymer (TSAN)), or a combination comprising one or more of the foregoing. For example, a combination of a heat stabilizer, mold release agent, and ultraviolet light stabilizer can be used. In general, the additives are used in the amounts generally known to be effective. For example, the total amount of the additive composition (other than any impact modifier, filler, or reinforcing agent) can be about 0.001 wt. % to about 10.0 wt. %, or about 0.01 wt. % to about 5 wt %, or any intervening ranges including from about 0.01 wt. % to about 1 wt. %, from about 0.01 wt. % to about 2 wt. %, from about 0.01 wt. % to about 3 wt. %, from about 0.01 wt. % to about 4 wt. %, from about 0.01 wt. % to about 6 wt. %, from about 0.01 wt. % to about 7 wt. %, from about 0.01 wt. % to about 8 wt. %, and/or from about 0.01 wt. % to about 9 wt. %, each based on the total weight of the polymer in the composition.

### Articles

In one aspect, the present invention pertains to shaped, formed, or molded articles comprising the disclosed thermoplastic compositions. The thermoplastic compositions can be molded into useful shaped articles by a variety of means such as injection molding, extrusion, rotational molding, blow molding and thermoforming to form articles such as, for example, various components for cell phones and cell phone covers, components for computer housings, computer housings and business machine housings such as housings for monitors, handheld electronic device housings such as housings for cell phones, electrical connectors, and components of lighting fixtures, ornaments, home appliances, roofs, greenhouses, sun rooms, swimming pool enclosures, Light Emitting Diodes (LEDs) and light panels, extruded film and sheet articles, and the like.

The disclosed compositions are of particular utility in the manufacture of thin walled articles such as pipette tips or housings for electronic devices. Additional examples of articles that can be formed from the compositions include electrical parts, such as relays, and enclosures, consumer electronics such as enclosures and parts for laptops, desktops, docking stations, PDAs, digital cameras, desktops, and telecommunications parts such as parts for base station terminals. As noted above, the disclosed composites are well suited for use in the manufacture of electronic components and devices. As such, according to some aspects, the disclosed composites can be used to form articles such as printed circuit board carriers, burn in test sockets, flex brackets for hard disk drives, and the like.

In various aspects, the invention pertains to an article selected from a molded article, a thermoformed article, a foamed article, an extruded film, an extruded sheet, one or more layers of a multi-layer article, a substrate for a coated article or a substrate for a metallized article comprising any of the disclosed thermoplastic compositions.

In various aspects, the invention pertains to articles of manufacture formed from a disclosed thermoplastic composition. In a further aspect, the article is an injection molded part. In a yet further aspect, the article is an extruded film or sheet. In an even further aspect, the article is a component for an electronic device.

In at least one aspect, the article is an injection molded article. In a further aspect, the article is an extruded film or sheet. The disclosed thermoplastic compositions can be formed into the article, film, or sheet using conventional methods.

In an even further aspect, the article, film, or sheet can be used to form an apparatus. In a yet further aspect, the article can have one or more apertures.

In a further aspect, non-limiting examples of devices which can comprise the disclosed thermoplastic compositions according to the present invention include computer devices, household appliances, decoration devices, electromagnetic interference devices, printed circuits, Wi-Fi devices, Bluetooth devices, GPS devices, cellular antenna devices, smart phone devices, automotive devices, military devices, aerospace devices, medical devices, such as hearing aids, sensor devices, security devices, shielding devices, RF antenna devices, or RFID devices.

In various aspects, the article may be a component for a medical device for applications in the field of healthcare. For example, the article comprising the disclosed thermoplastic composition can be used in pipette tips The conductive polypropylene can allow the static electricity generated by the flow of the liquid to be discharged through the tip rack.

In at least one aspect, the article is a component for an electronic device.

In a further aspect, the article is selected from a computer device, electromagnetic interference device, printed circuit, Wi-Fi device, Bluetooth device, GPS device, gaming device, cellular antenna device, smart phone device, a laptop computer, a tablet computer, an e-reader device, a copier device, automotive device, medical device, sensor device, security device, shielding device, RF antenna device, LED device, and RFID device. For example, the article can be a component of a smart phone. In yet a further aspect, the article is selected from a computer device, sensor device, security device, RF antenna device, LED device and RFID device. In an even further example, the article is selected from a computer device, RF antenna device, LED device and RFID device. In a still further aspect, the article is selected from a RF antenna device, LED device and RFID device. In yet a further aspect, the article is selected from a RF antenna device and RFID device. In an even further aspect, the article is a LED device. In a still further aspect, the LED device is selected from a LED tube, a LED socket, and a LED heat sink. In another aspect, the article is a component for a sports goggle or an eyeglass frame.

In a further aspect, the article is a component for an electronic housing. In a still further aspect, the electronic housing is a component for a cell phone, smart phone, GPS device, laptop computer, tablet computer, e-reader, or copier. In a yet further aspect, the electronic housing is a component for a cell phone or smart phone. In an even further aspect, the electronic housing is a component for a GPS device. In a still further aspect, the electronic housing is a component for a laptop computer, tablet computer, or e-reader.

In a further aspect, the molded articles can be used to manufacture devices in the automotive field. In a still further aspect, non-limiting examples of such devices in the automotive field which can use the disclosed blended thermoplastic compositions in the vehicle's interior include adaptive cruise control, headlight sensors, windshield wiper sensors, and door/window switches. In a further aspect, non-limiting examples of devices in the automotive field which can comprise the disclosed blended thermoplastic compositions in the vehicle's exterior include pressure and flow sensors for engine management, air conditioning, crash detection, and exterior lighting fixtures.

In various aspects, the article is an outdoor electric enclosure.

In a further aspect, the article is a component of an electric vehicle charging system.

In a further aspect, the article is a component of a photovoltaic junction connector or photovoltaic junction box.

In various aspects, the invention pertains to articles of manufacture, comprising: a molded body formed from the thermoplastic composition; wherein the molded body has at least one surface exhibiting electrical conductivity; and wherein the thermoplastic composition comprises a means for providing the at least one improved electrical conductivity property.

It is also to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polypropylene polymer” includes mixtures of two or more polypropylene polymers.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight, of a particular element or component in a composition or article, denote the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt. %,” and “wt. %” of a component, which can be used interchangeably, unless specifically stated to the contrary, are based on the total weight of the formulation or composition in which the component is included. For example if a particular element or component in a composition or article is said to have 8% by weight, it is understood that this percentage is relative to a total compositional percentage of 100% by weight.

Compounds are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this disclosure belongs.

The present disclosure comprises at least the following aspects.

Aspect 1. A thermoplastic composition exhibiting conductive and static dissipative properties comprising: from about 78 wt. % to about 81 wt. % of a polypropylene polymer component, wherein the polypropylene polymer component comprises a polypropylene copolymer and a polypropylene homopolymer; from about 18 wt. % to about 22 wt. % of carbon black; from about 0.03 wt. % to about 0.05 wt. % of a peroxide; and from about 0.5 wt. % to about 1 wt. % of a mold release additive, wherein the combined weight percent value of all components does not exceed about 100 wt. %, and wherein all weight percent values are based on the total weight of the composition.

Aspect 2. A thermoplastic composition exhibiting conductive and static dissipative properties comprising: from about 75 wt. % to about 84 wt. % of a polypropylene polymer component, wherein the polypropylene polymer component comprises a polypropylene copolymer and a polypropylene homopolymer; from about 15 wt. % to about 25 wt. % of an electrically conductive filler component; from about 0.01 wt. % to about 0.05 wt. % of a polymer chain modifier additive component; and from about 0.2 wt. % to about 2 wt. % of a mold release additive, wherein the combined weight percent value of all components does not exceed about 100 wt. %, and wherein all weight percent values are based on the total weight of the composition.

Aspect 3. The thermoplastic composition of any of aspects 1-2, wherein the polypropylene homopolymer comprises less than half of the total weight of the polypropylene polymer component.

Aspect 4. The thermoplastic composition of any of aspects 1-2, wherein the polypropylene homopolymer is present in an amount of from about 15 wt. % to about 35 wt. % of the total weight of the polypropylene polymer component and wherein the polypropylene copolymer component is present in an amount of from about 65 wt. % to about 85 wt. % of the total weight of the polypropylene polymer component.

Aspect 5. The thermoplastic composition of any of aspects 1-2, wherein the polypropylene homopolymer is present in an amount of from about 25 wt. % to about 35 wt. % of the total weight of the polypropylene polymer component and wherein the polypropylene copolymer component is present in an amount of from about 65 wt. % to about 75 wt. % of the total weight of the polypropylene polymer component.

Aspect 6. The thermoplastic composition of any one of aspects 1-5, wherein the polypropylene homopolymer has a melt flow index of greater than about 15 25 g/10 minutes as measured according to a temperature of about 230° C. and under 2.16 kg load.

Aspect 7. The thermoplastic composition of any one of aspects 1-6, wherein the polypropylene copolymer has a notched Izod impact strength of greater than about 180 J/m measured at room temperature.

Aspect 8. The thermoplastic composition of any one of aspects 1-7, wherein the polypropylene copolymer has a melt flow index of more than about 10 g/10 min at a temperature of about 230° C. and under 2.16 kg load.

Aspect 9. The thermoplastic composition of any one of aspects 1-8, wherein the electrically conductive filler is carbon black.

Aspect 10. The thermoplastic composition of any one of aspects 1-9, wherein the polymer chain modifier component is a peroxide.

Aspect 11. The thermoplastic composition of aspect 10, wherein the peroxide is a concentrate in a polypropylene carrier.

Aspect 12. The thermoplastic composition of any one of aspects 9-11, wherein the peroxide is a 20% peroxide concentrate in a polypropylene carrier.

Aspect 13. The thermoplastic composition of any one of aspects 1-12, wherein the mold release additive is pentaerythritol stearate.

Aspect 14. The thermoplastic composition of any one of aspects 1-13, wherein the thermoplastic composition has a surface resistivity of less than 200 ohm/sq.

Aspect 15. The thermoplastic composition of any one of aspects 1-14, wherein the thermoplastic composition has a notched impact strength of greater than about 300 J/m at 23° C.

Aspect 16. The thermoplastic composition of any one of aspects 1-15, wherein the thermoplastic composition exhibits 100% ductility in notched and unnotched Izod impact tests.

Aspect 17. The thermoplastic composition of any one of aspects 1-16, wherein the thermoplastic composition has a melt volume rate of greater than about 15 cm3/10 min at 190° C. and under 2.16 kg of load.

Aspect 18. The thermoplastic composition of any one of aspects 1-17, wherein the thermoplastic composition exhibits a mold release ejection pressure of less than 500 psi.

Aspect 19. An article of manufacture comprising the thermoplastic composition of any one of aspects 1-18.

Aspect 20. A method of forming a thermoplastic composition comprising mixing: from about 75 wt. % to about 84 wt. % of a polypropylene polymer component, wherein the polypropylene polymer component comprises a polypropylene copolymer and a polypropylene homopolymer; from about 15 wt. % to about 25 wt. % of an electrically conductive filler component; from about 0.01 wt. % to about 0.05 wt. % of a polymer chain modifier component; and from about 0.2 wt. % to about 2 wt. % of a mold release additive, wherein the combined weight percent value of all components does not exceed about 100 wt. %, and wherein all weight percent values are based on the total weight of the composition.

Aspect 21. The method of aspect 20 further comprising extruding the thermoplastic composition.

Aspect 22. An article manufactured by the method of aspect 20.

### Examples

The disclosed composition is illustrated by the following non-limiting examples. The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt. %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### General Materials and Methods

In the examples, polypropylene homopolymer, copolymer or their blends, stabilizers, flow modifier, and mold release agent (where applicable) were introduced at the feed throat of ten-barrel 40 mm twin screw extruders. The conductive filler was added via a side feeder. The compositions were extruded with a barrel temperature of 420° F. at a screw speed of 200 rpm and a feed rate of 100 lb/hour. Molded articles were prepared for analysis. The samples were injection molded at a barrel temperature of 420° F. and a mold temperature of 100° F.

Physical measurements were made using the tests and test methods described herein.

A notched Izod impact (“NII”) test was carried out on 63.5 mm×12.7 mm×3.18 mm molded samples (bars) according to ASTM D 256 at 23° C. Test samples were conditioned in ASTM standard conditions of 23° C. and 55% relative humidity for 48 hours and then were evaluated.

An unnotched Izod impact test was carried out on molded parts (bars) according to ASTM D 4812 at 23° C. Test specimen was conditioned at ASTM standard conditions of 23° C. and 55% relative humidity for 48 hours and then evaluated.

A percent ductility of the samples was determined from the fracture mode of the samples during the notched and unnotched Izod impact testing. A 100% ductility determination indicates an incomplete break where the fracture extends less than 90% of the distance between the vertex of the notch and the opposite side of the sample. A 0% ductility determination indicates a complete break of the sample.

Melt Volume Rate (MVR) was determined according to ASTM 1238 at 190° C. under 2.16 kg of load.

Surface resistivity was measured according to according to ASTM D257 on a Keithley Model 6517A Electrometer/High Resistance Meter with a Keithley 8009 Resistivity Test Fixture. In this method, voltage was applied to the test specimen (a 3 inch by 2 inch by ⅛^{th} inch injection molded plaque) and after a given delay period (to allow for system stabilization) the meter reported the surface resistivity of the sample in ohms/square. The applied voltage was maintained in the range of about 0.1 V to about 1 V for all testing.

Mold release performance was assessed according to the following method. The thermoplastic composition is introduced into an injection mold using a hydraulic injection molding machine. The ejection pressure applied to release the composition from the core of the injection molding machine corresponds to the mold release performance of the sample. An injection pressure greater than or equal to 750 psi indicates poor mold release performance, or mold releasability. An injection pressure less than or equal to 500 psi indicates good mold releasability of the sample.

As a non-limiting example, sample compositions were prepared from the components described in Table 1.

TABLE 1
Thermoplastic Composition Components

| Item | Description | Supplier |
|---|---|---|
| CB | Timcal Ensaco 250 G; carbon black. Density | Timcal |
| | 0.2 g/cc, Surface area 65 m²/g, volume | Begium S.A. |
| | resistivity <=10 ohm-cm | |
| PP-HP | Bapolene 4082; Polypropylene | Bamberger |
| | homopolymer. Density 0.90 g/cc, MFR (at | Polymers, |
| | 230° C., 2.16 kg) 35 g/10 min, Notched Izod | Inc. |
| | impact 21 J/m. | |
| PP-CP | Basell Profax SG-702; PP copolymer. | Basell |
| | Density 0.90 g/cc, MFR (at 230° C./2.16 | |
| | Kg) 18 g/10 min, notched Izod impact (at | |
| | 23° C.) 235 J/m | |
| PS-1 | BASF Irgafos 168; processing stabilizer. | BASF |
| | Density 1.03 g/cc, melting range 183-186° C. | |
| PS-2 | BASF 1010 Irganox; Processing stabilizer. | BASF |
| | Density 1.15 g/cc, melting range 110-125° C. | |
| PO Conc. | Polyvel Peroxide CR-20P; 20% peroxide | Polyvel Inc. |
| | concentrate in a polypropylene carrier. | |
| | Bulk density 570 g/L | |
| PETS | Lonza Glycolube Pentaerythritol stearate; | Lonza Inc. |
| | lubricant/mold release. Melting point 60-65° C. | |

Table 2 describes the thermoplastic composition of comparative and inventive samples. Comparative samples C1-C4 and inventive samples S1-S10 were prepared based on the comparable resin composition, wherein the amounts of polypropylene homopolymer and copolymer were varied; wherein the amount of polymer chain modifier peroxide CR20P was varied (for samples S1-S10); and wherein a mold release agent was introduced (for samples S7-S10). All the formulations in Table 2 comprise 19 wt. % carbon black.

TABLE 2
Formulation details of samples.

| | | | PP- | | | | PO | | |
|---|---|---|---|---|---|---|---|---|---|
| | | CB | HP | PP-CP | PS-1 | PS-2 | Conc. | PETS | Total |
| Sample | CS1 | 19 | 80.80 | | 0.1 | 0.1 | | | 100 |
| Number | CS2 | 19 | | 80.80 | 0.1 | 0.1 | | | 100 |
| | CS3 | 19 | 40.40 | 40.40 | 0.1 | 0.1 | | | 100 |
| | CS4 | 19 | 56.56 | 24.24 | 0.1 | 0.1 | | | 100 |
| | S1 | 19 | | 80.20 | 0.1 | 0.1 | 0.6 | | 100 |
| | S2 | 19 | | 79.80 | 0.1 | 0.1 | 1 | | 100 |
| | S3 | 19 | 21.78 | 58.87 | 0.1 | 0.1 | 0.15 | | 100 |
| | S4 | 19 | 25.00 | 55.65 | 0.1 | 0.1 | 0.15 | | 100 |
| | S5 | 19 | 21.76 | 58.84 | 0.1 | 0.1 | 0.2 | | 100 |
| | S6 | 19 | 24.99 | 55.61 | 0.1 | 0.1 | 0.2 | | 100 |
| | S7 | 19 | 21.58 | 58.32 | 0.1 | 0.1 | 0.15 | 0.75 | 100 |
| | S8 | 19 | 24.71 | 55.19 | 0.1 | 0.1 | 0.15 | 0.75 | 100 |
| | S9 | 19 | 21.56 | 58.29 | 0.1 | 0.1 | 0.2 | 0.75 | 100 |
| | S10 | 19 | 24.70 | 55.15 | 0.1 | 0.1 | 0.2 | 0.75 | 100 |

Physical measurements were made using the tests and test methods described herein.

Typical flow and physical properties as well as surface resistivity are shown in Table 4 for the thermoplastic compositions presented in Table 3. Comparative sample CS1 exhibits the poorest values for impact strength and ductility, but also shows moderate flow and low surface resistivity (a low surface resistivity indicates high electrical conductivity). Improved impact strength results are observed for comparative sample CS2 wherein the polypropylene component comprises only the polypropylene copolymer. Nevertheless, CS2 has a significantly low melt volume rate and higher surface resistivity. CS3 and CS4 also show improvements in flow and electrical conductivity, but a sharp decline in notched Izod impact strength and ductility when compared to CS2. Comparative samples CS3 and CS4 also demonstrate the significance of the proportion of polypropylene homopolymer and copolymer in the composition. CS3 where the polypropylene homopolymer and copolymer are at an equal weight percent of the total composition exhibits improved impact strength compared to CS4 where the polypropylene homopolymer comprises a higher portion of the polypropylene polymer component. CS3 however has a significantly higher surface resistivity.

Samples S1 and S2 comprising the conductive filler, peroxide modifier and only polypropylene copolymer within the polypropylene component show improved flow compared to CS2. However, notched Izod impact strength and notched Izod ductility are significantly diminished. Also, 51 and S2 have significantly higher surface resistivity than CS1, CS3, and CS4. Samples S3 to S10, (having peroxide at less than 0.06 wt. % of the total composition and the polypropylene homopolymer at a lower weight percentage of the total weight of the polypropylene component) exhibit good flow, good surface resistivity, and good notched and unnotched Izod impact strength.

The introduction of the mold release additive in samples S7 to S10 provides improved mold release ability for the composition. As shown in Table 3, samples S7 to S10 required an ejection pressure of less than 500 psi to release from the parts of the core of an injection molding machine. An ejection pressure of less than 500 psi indicates good mold releasability. Moreover, these results prove surprising in that the mold release additive improved not only the mold release performance of the thermoplastic resin, but has also improved flow and 100% ductility in notched impact testing for samples S7-S10.

TABLE 3
Physical properties of molded samples.

| | | Notched | | Unnotched | | MVR at | | Required |
|---|---|---|---|---|---|---|---|---|
| | | Izod | NII | Izod | UNII | 190° C., | Surface | Injection |
| | | Impact, | Ductility | Impact, | Ductility | 2.16 Kg | Resistivity | pressure |
| | | NII (J/m) | (%) | UNII (J/m) | (%) | (cm³/10 min) | (ohm/sq.) | (psi) |
| Sample Number | CS1 | 16 | 0 | 305 | 0 | 12 | 60 | >750 (Poor) |
| | CS2 | 848 | 100 | 1490 | 100 | 6 | 290 | >750 (Poor) |
| | CS3 | 157 | 0 | 1270 | 0 | 9.5 | 132 | >750 (Poor) |
| | CS4 | 65 | 0 | 831 | 0 | 10.5 | 90 | >750 (Poor) |
| | S1 | 198 | 0 | 1130 | 100 | 31 | 316 | >750 (Poor) |
| | S2 | 126 | 0 | 1120 | 100 | 60 | 366 | >750 (Poor) |
| | S3 | 599 | 0 | 1280 | 100 | 15.7 | 107 | >750 (Poor) |
| | S4 | 582 | 0 | 1380 | 100 | 16 | 92 | >750 (Poor) |
| | S5 | 609 | 0 | 1290 | 100 | 19.2 | 98 | >750 (Poor) |
| | S6 | 260 | 0 | 1340 | 100 | 20 | 90 | >750 (Poor) |
| | S7 | 627 | 100 | 1370 | 100 | 17.3 | 116 | <500 (Good) |
| | S8 | 570 | 100 | 1390 | 100 | 18.1 | 99 | <500 (Good) |
| | S9 | 561 | 100 | 1330 | 100 | 19.5 | 107 | <500 (Good) |
| | S10 | 496 | 100 | 1390 | 100 | 21.4 | 100 | <500 (Good) |

The disclosed formulations described hereinabove provide electrically conductive thermoplastic compositions having high ductility, high notched Izod impact strength (>300 J/m) and unnotched Izod impact strength (>1000 J/m), good flow (>15 cm³/10 min at 190° C. under a 2.16 kg load), and good mold release performance indicated by an ejection pressure of less than 500 psi. The demonstrated characteristics of the disclosed formulations make them well-suited for use in articles of manufacture in the medical, electric and electronic markets, especially those requiring thin-walled components.

1. A thermoplastic composition exhibiting conductive and static dissipative properties, the thermoplastic composition comprising:
from about 78 wt. % to about 81 wt. % of a polypropylene polymer component, wherein the polypropylene polymer component comprises a polypropylene copolymer and a polypropylene homopolymer;
from about 18 wt. % to about 22 wt. % of carbon black;
from about 0.15 wt. % to about 0.2 wt. % of a peroxide; and
from about 0.5 wt. % to about 1 wt. % of a mold release additive,
wherein the combined weight percent value of all components does not exceed about 100 wt. %, and wherein all weight percent values are based on the total weight of the composition.

2. A thermoplastic composition exhibiting conductive and static dissipative properties comprising:
from about 75 wt. % to about 84 wt. % of a polypropylene polymer component, wherein the polypropylene polymer component comprises a polypropylene copolymer and a polypropylene homopolymer;
from about 15 wt. % to about 25 wt. % of an electrically conductive filler component;
from about 0.15 wt. % to about 1 wt. % of a; and
from about 0.2 wt. % to about 2 wt. % of a mold release additive,
wherein the combined weight percent value of all components does not exceed about 100 wt. %, and wherein all weight percent values are based on the total weight of the composition.

3. The thermoplastic composition of claim 2, wherein the polypropylene homopolymer comprises less than half of the total weight of the polypropylene polymer component.

4. The thermoplastic composition of claim 2, wherein the polypropylene homopolymer is present in an amount of from about 25 wt. % to about 35 wt. % of the total weight of the polypropylene polymer component and wherein the polypropylene copolymer component is present in an amount of from about 65 wt. % to about 75 wt. % of the total weight of the polypropylene polymer component.

5. The thermoplastic composition of claim 2, wherein the polypropylene homopolymer has a melt flow index of greater than about 25 g/10 minutes as measured according to ASTM 1238 at a temperature of about 230° C. and under 2.16 kg load.

6. The thermoplastic composition of claim 2, wherein the polypropylene copolymer has a notched Izod impact strength of greater than about 180 J/m measured at room temperature measured according to ASTM D 256.

7. The thermoplastic composition of claim 2, wherein the polypropylene copolymer has a melt flow index of more than about 10 g/10 min measured according to ASTM 1238 at a temperature of about 230° C. and under 2.16 kg load.

8. The thermoplastic composition of claim 2, wherein the electrically conductive filler is carbon black.

9. (canceled)

10. The thermoplastic composition of claim 2, wherein the peroxide is a concentrate in a polypropylene carrier.

11. The thermoplastic composition of claim 2, wherein the peroxide is a 20% peroxide concentrate in a polypropylene carrier.

12. The thermoplastic composition of claim 2, wherein the mold release additive is pentaerythritol stearate.

13. The thermoplastic composition of claim 2, wherein the thermoplastic composition has a surface resistivity of less than 200 ohm/sq.

14. The thermoplastic composition of claim 2, wherein the thermoplastic composition has a notched impact strength of greater than about 300 J/m at 23° C. measured according to ASTM D 256.

15. The thermoplastic composition of claim 2, wherein the thermoplastic composition exhibits 100% ductility in notched and unnotched Izod impact tests measured at room temperature according to ASTM D 256 and ASTM D 4812, respectively.

16. The thermoplastic composition of claim 2, wherein the thermoplastic composition has a melt volume rate of greater than about 15 cm³/10 min according to ASTM 1238 at 190° C. and under 2.16 kg of load.

17. The thermoplastic composition of claim 2, wherein the thermoplastic composition exhibits a mold release ejection pressure of less than 500 psi.

18. An article of manufacture comprising the thermoplastic composition of claim 2.

19. A method of forming a thermoplastic composition comprising mixing:
from about 75 wt. % to about 84 wt. % of a polypropylene polymer component, wherein the polypropylene polymer component comprises a polypropylene copolymer and a polypropylene homopolymer;
from about 15 wt. % to about 25 wt. % of an electrically conductive filler component;
from about 0.15 wt. % to about 1 wt. % of a; and
from about 0.2 wt. % to about 2 wt. % of a mold release additive,
wherein the combined weight percent value of all components does not exceed about 100 wt. %, and wherein all weight percent values are based on the total weight of the composition.

20. An article manufactured by the method of claim 19.

21. The thermoplastic composition of claim 1, wherein the thermoplastic composition exhibits a mold release ejection pressure of less than 500 psi.
